(19) United States
(12) Patent Application Publication
(10) Pub. No.: US 2013/0075008 A1
(43) Pub. Date: Mar. 28, 2013

(54) Pneumatic Tire

(71) Applicant: The Yokohama Rubber Co., LTD., Sandy, UT (US)

(72) Inventors: Hiroyuki Miyajima, Haratsuka-shi (JP); Masatoshi Kuwajima, Hiratsuka-shi (JP)

(73) Assignee: The Yokohama Rubber Co., LTD., Sandy, UT (US)

(21) Appl. No.: 13/631,078

(22) Filed: Sep. 28, 2012

(30) Foreign Application Priority Data
Sep. 28, 2011 (JP) 2011-212788

(51) Int. Cl. B60C 13/02

(52) U.S. Cl. CPC B60C 13/02
USPC 152/523

(57) ABSTRACT

A pneumatic tire having tire side portions S on both sides that form regions from a ground contact edge to a rim check line includes a plurality of inner side recesses provided in a surface of the tire side portion on a vehicle inner side, when mounted on a vehicle; and a plurality of outer side recesses provided in a surface of the tire side portion on a vehicle outer side, when mounted on a vehicle. In this pneumatic tire, a region where the plurality of inner side recesses is provided is an inner side disposal region and a region where the plurality of outer side recesses is provided is an outer side disposal region. The inner side disposal region and the outer side disposal region are different regions in a plane projected in a tire width direction.

### PRIORITY CLAIM

Priority is claimed to Japan Patent Application Serial No. 2011-212788 filed on Sep. 28, 2011.

### BACKGROUND

1. Technical Field

The present technology relates to a pneumatic tire.

2. Related Art

A pneumatic tire provided with a circular decorative body in at least one side wall portion is known (e.g. see Japanese Unexamined Patent Application Publication No. H11-321243A). In such a pneumatic tire, a plurality of protrusions is formed on a surface of the circular decorative body. By forming the plurality of protrusions, unevennesses occurring in the side wall portion and appearance flaws of the tire caused by mold processing can be obscured.

Additionally, a pneumatic tire provided with a plurality of recesses in a tire outer side surface, throughout a tire circumferential direction and a tire radial direction, is known (e.g. see Japanese Unexamined Patent Application Publication No. 2010-260377A). In such a pneumatic tire, air resistance when traveling is reduced due to the plurality of recesses in the tire outer side surface. Note that the plurality of recesses is provided in a predetermined region of the tire outer side surface, and is provided on both sides in a width direction or on an outer side in the width direction of a vehicle, when mounted on a vehicle.

However, with a tire for mounting on a vehicle, the side wall portion of a first side is exposed to the outer side in the width direction of the vehicle and the side wall portion of a second side is housed in a wheel housing on an inner side in the width direction of the vehicle. The tire for mounting on the vehicle receives air resistance when traveling, and is subject to temperature increases clue to heat buildup caused by deformation, waste heat from the vehicle, and the like. Here, the air flowing along the side wall portion on a vehicle outer side separates easier compared with the side wall portion on the inner side that is housed in the wheel housing of the vehicle because the side wall portion on the vehicle outer side is exposed. If the air flowing along the side wall portion separates, the air flow will expand due to the air flowing in a direction separating from the tire and, as a result, the air resistance applied to the tire will increase. Therefore, the side wall portion on the vehicle outer side is more prone to be affected by air resistance compared with the side wall portion on the vehicle inner side. On the other hand, the side wall portion on the vehicle inner side is housed in the wheel housing of the vehicle and, therefore, is more prone to temperature increases compared with the side wall portion of the vehicle outer side, which is exposed.

In Japanese Unexamined Patent Application Publication No. H11-321243A, a plurality of protrusions is formed on the side wall portion. Additionally, in Japanese Unexamined Patent Application Publication No. 2010-260377A, the plurality of recesses provided in the tire outer side surface is provided on both sides in the width direction or on the outer side in the width direction of the vehicle, when mounted on a vehicle. Therefore, in cases where the plurality of recesses is provided in both side in the width direction of the vehicle, the arrangement of the plurality of recesses is not taken into consideration and, as a result, the ease of separation of the air of the side wall portion on the vehicle outer side and the ease of temperature increase of the side wall portion on the vehicle inner side are not taken into consideration. Therefore, it is difficult to reduce the air resistance and suppress the temperature increases. Likewise, in cases where the plurality of recesses is provided only in the outer side in the width direction of the vehicle, the plurality of recesses is not provided in the inner side in the width direction of the vehicle and, as a result, it is difficult to suppress the temperature increases of the side wall portion on the vehicle inner side.

### SUMMARY

The present technology provides a pneumatic tire that is mountable on a vehicle by which air resistance can be reduced and temperature increases can be suppressed. A pneumatic tire of the present technology has tire side portions on both sides that form regions extending from a ground contact edge to a rim check line includes a plurality of inner side recesses provided in a surface of the tire side portion on an inner side in a width direction of a vehicle, when mounted on a vehicle; and a plurality of outer side recesses provided in a surface of the tire side portion on an outer side in a width direction of a vehicle, when mounted on a vehicle. In this pneumatic tire, a region where the plurality of inner side recesses is provided is an inner side disposal region and a region where the plurality of outer side recesses is provided is an outer side disposal region. The inner side disposal region and the outer side disposal region are different regions in a plane projected in a tire width direction.

In one example, in a tire radial direction, the outer side disposal region is preferably a region including at least the ground contact edge, and in the tire radial direction, the inner side disposal region is preferably a region including at least a maximum width position where the tire width is greatest.

In one example, a sum of volumes of the plurality of inner side recesses and a sum of volumes of the plurality of outer side recesses are preferably equal.

In one example, the sum of volumes of the plurality of inner side recesses is preferably greater than the sum of volumes of the plurality of outer side recesses.

In one example, the sum of volumes of the plurality of outer side recesses is ably greater than the sum of volumes of the plurality of inner side recesses.

In one example, a depth of the inner side recesses and the outer side recesses is preferably not less than 0.5 mm and not more than 5.0 mm.

In one example, an opening of the inner side recesses and the outer side recesses is preferably circular, and a diameter of said opening is preferably not less than 1.0 mm and not more than 8.0 mm.

According to the pneumatic tire of the present technology, the inner side disposal region in which the inner side recesses are provided and the outer side disposal region in which the outer side recesses are provided may be different regions in a plane projected in a tire width direction. Therefore, the inner side disposal region is configured to have an arrangement suitable for the tire side portion on the inner side in the width direction of the vehicle and, thereby, the ease of temperature increase in the tire side portion on the vehicle inner side can be taken into consideration. Moreover, the outer side disposal region is configured to have an arrangement suitable for the tire side portion on the outer side in the width direction of the vehicle and, thereby, the ease of separation of air of the tire side portion on the vehicle outer side can be taken into consideration. As a result, the arrangements of the inner side disposal region and the outer side disposal region are optimized and, thereby, the air resistance can be reduced and the temperature increases can be suppressed.

### BRIEF DESCRIPTION OF THE DRAWINGS

FIG. 1 is a meridian cross-sectional view of a pneumatic tire according to an embodiment.

FIG. 2 is a projection drawing illustrating an example of an outer side disposal region and an inner side disposal region of the pneumatic tire.

FIG. 3 is a projection drawing illustrating another example of an outer side disposal region and an inner side disposal region of the pneumatic tire.

FIG. 4 is a projection drawing illustrating another example of an outer side disposal region and an inner side disposal region of the pneumatic tire.

FIG. 5 is a projection drawing illustrating another example of at outer side disposal region and an inner side disposal region of the pneumatic tire.

FIG. 6 is a table in which Working Examples of the pneumatic tire according to this embodiment are compared.

### DETAILED DESCRIPTION

An embodiment of the present technology is described below in detail based on the drawings. However, the present technology is not limited to this embodiment. The constituents of the embodiment include constituents that can be easily replaced by those skilled in the art and constituents substantially same as the constituents of the embodiment. Furthermore, the multiple Working Examples described in the embodiment can be combined as desired within the scope apparent to a person skilled in the art.

### Embodiment

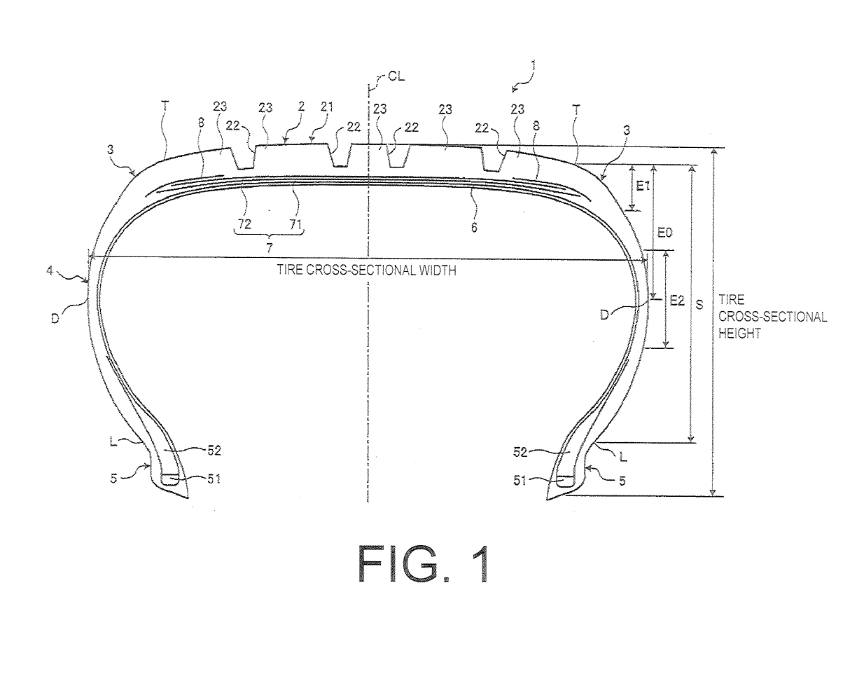

FIG. 1 is a meridian cross-sectional view of a pneumatic tire according to this embodiment. In the following description, “tire radial direction” refers to a direction orthogonal to the rotational axis (not shown) of the pneumatic tire 1; “inner side in the tire radial direction” refers to the side facing the rotational axis in the tire radial direction; and “outer side in the tire radial direction” refers to the side distanced from the rotational axis in the tire radial direction. “Tire circumferential direction” refers to a circumferential direction with the rotational axis as a center axis. Additionally, “tire width direction” refers to the direction parallel to the rotational axis; “inner side in the tire width direction” refers to the side facing a tire equatorial plane CL (tire equator line) in the tire width direction; and “outer side in the tire width direction” refers to the side distanced from the tire equatorial plane CL in the tire width direction. “Tire equatorial plane CL” refers to a plane that is orthogonal to the rotational axis of the pneumatic tire 1 and that passes through a center of a tire cross-sectional width of the pneumatic tire 1. “Tire cross-sectional width” refers to a width where a height of a design formed in the surface of the outer side in the tire width direction is subtracted from a total width of the pneumatic tire 1. “Tire cross-sectional height” refers to ½ of a height found by subtracting a rim diameter from an outer diameter of the pneumatic tire 1. “Tire equator line” refers to a line along the tire circumferential direction of the pneumatic tire 1 that lies on the tire equatorial plane CL. In this embodiment, “tire equator line” is given the same “CL” reference symbol as that used for the tire equatorial plane.

In cases where the pneumatic tire 1 of this embodiment is mounted on a vehicle (not illustrated), orientations with respect to the inner side and the outer side in the tire width direction of the vehicle are designated. The orientation designations, while not explicitly illustrated in the drawings, for example, can be shown via indicators provided on the side wall portions 4. Hereinafter, when mounted on a vehicle, a side facing the inner side in the width direction of the vehicle is referred to as a “vehicle inner side” and a side icing the outer side in the width direction of the vehicle is referred to as a “vehicle outer side”. Note that the designations of the vehicle inner side and the vehicle outer side are not limited to cases when mounted on the vehicle. For example, in cases when assembled on a rim, orientation of the rim with respect to the inner side and the outer side of the vehicle in the tire width direction is set. Therefore, in cases when the pneumatic tire 1 is assembled on a rim, the orientation with respect to the inner side (vehicle inner side) and the outer side (vehicle outer side) of the vehicle in the tire width direction is designated.

Note that the pneumatic tire 1 of this embodiment is described as being used as a passenger car tire, but may also be used as a run flat tire or a heavy load tire.

As illustrated in FIG. 1, the pneumatic tire 1 of this embodiment includes a tread portion 2, shoulder portions 3 on both sides of the tread portion 2, and a side wall portion 4 and a head portion 5 continuing sequentially from each of the shoulder portions 3. Additionally, the pneumatic tire 1 includes a carcass layer 6, a belt layer 7, and a belt reinforcing layer 8.

The tread portion 2 is formed from a rubber material (tread rubber), is exposed on the outermost side in the tire radial direction of the pneumatic tire 1, and a surface thereof constitutes a profile of the pneumatic tire 1. A tread surface 21 is formed on a peripheral surface of the tread portion 2 or, rather, on a road contact surface that contacts a road surface when traveling. The tread surface 21 extends along the tire circumferential direction, and a plurality (four in this embodiment) of main grooves 22 that are straight main grooves parallel with the tire equator line CL are provided in the tread surface 21. The plurality of main grooves 22 is disposed symmetrically around the tire equator line CL. Moreover, a plurality of rib-like land portions 23 extending along the tire circumferential direction and parallel with the tire equator line CL is formed in the tread surface 21 by the plurality of main grooves 22. Additionally, while not explicitly illustrated in the drawings, lug grooves that intersect with the main grooves 22 in each of the land portions 23 are provided in the tread surface 21. The land portions 23 are plurally divided in the tire circumferential direction by the lug grooves. Additionally, the lug grooves are formed so as to Open to an outermost side in the tire width direction of the tread portion 2, that is, the outer side in the tire width direction. Note that the lug grooves may have a form that communicates with the main grooves 22 or may have a form that does not communicate with the main grooves 22.

The shoulder portions 3 are locations on both outer sides in the tire width direction of the tread portion 2. Additionally, the side wall portions 4 are exposed at an outermost side in the tire width direction of the pneumatic tire 1. The bead portions 5 include a bead core 51 and a bead filler 52. The bead core 51 is formed by winding a steel wire (bead wire) in a ring-like manner. The bead filler 52 is a rubber material that is disposed in space formed by ends of the carcass layer 6 in the tire width direction being folded up at a position of the bead core 51.

The ends of the carcass layer 6 in the tire width direction are folded over the pair of bead cores 51 from the inner side in the tire width direction to the outer side in the tire width direction, and the carcass layer 6 is stretched in a toroidal shape in the tire circumferential direction to form the framework of the tire. The carcass layer 6 is constituted by a plurality of carcass cords (not illustrated) juxtaposed in the tire circumferential direction along the tire meridian direction having a given angle with respect to the tire circumferential direction, and covered by a coating rubber. The carcass cords are formed from organic fibers (e.g. polyester, rayon, nylon, or the like). At least one layer of this carcass layer 6 is provided.

The belt layer 7 has a multi-layer structure where at least two layers (belts 71 and 72) are stacked; is disposed on an outer side in the tire radial direction that is the periphery of the carcass layer 6, in the tread portion 2; and covers the carcass layer 6 in the tire circumferential direction. The belts 71 and 72 are constituted by a plurality of cords (not illustrated) juxtaposed at a predetermined angle with respect to the tire circumferential direction (e.g. from 20 degrees to 30 degrees), and covered by a coating rubber. The cords are formed from steel or organic fibers (e.g. polyester, rayon, nylon, or the like). Moreover, the overlapping belts 71 and 72 are disposed so that the cords thereof mutually cross.

The belt reinforcing layer 8 is disposed on the outer side in the tire radial direction that is the periphery of the belt layer 7, and covers the belt layer 7 in the tire circumferential direction. The belt reinforcing layer 8 is constituted by a plurality of cords (not illustrated), juxtaposed in the tire width direction and substantially parallel (e.g. ±5 degrees) to the tire circumferential direction, which are covered by a coating rubber. The cords are formed from steel or organic fibers (e.g. polyester, rayon, nylon, or the like). The belt reinforcing layer 8 illustrated in FIG. 1 is disposed so as to cover end portions in the tire width direction of the belt layer 7. The configuration of the belt reinforcing layer 8 is not limited to that described above. While not explicitly illustrated in the drawings, a configuration may be used where the belt reinforcing layer 8 is disposed so as to cover an entirety of the belt layer 7. Alternatively, for example, a configuration may be used where the belt reinforcing layer 8 has two reinforcing layers, where the belt reinforcing layer 8 is formed so that the reinforcing layer on the inner side in the tire radial direction is longer in the tire width direction than the belt layer 7 and disposed so as to cover the entirety of the belt layer 7, and the reinforcing layer on the outer side in the lire radial direction is disposed so as only to cover the end portions in the tire width direction of the belt layer 7. Alternatively, for example, a configuration may be used where the belt reinforcing layer 8 has two reinforcing layers, where each of the reinforcing layers is disposed so as only to cover the end portions in the tire width direction of the belt layer 7. In other words, the belt reinforcing layer 8 overlaps with at least the end portions in the tire width direction of the belt layer 7. Additionally, the belt reinforcing layer 8 is provided by winding band-like (e.g. with a width of 10 mm) strip material in the tire circumferential direction.

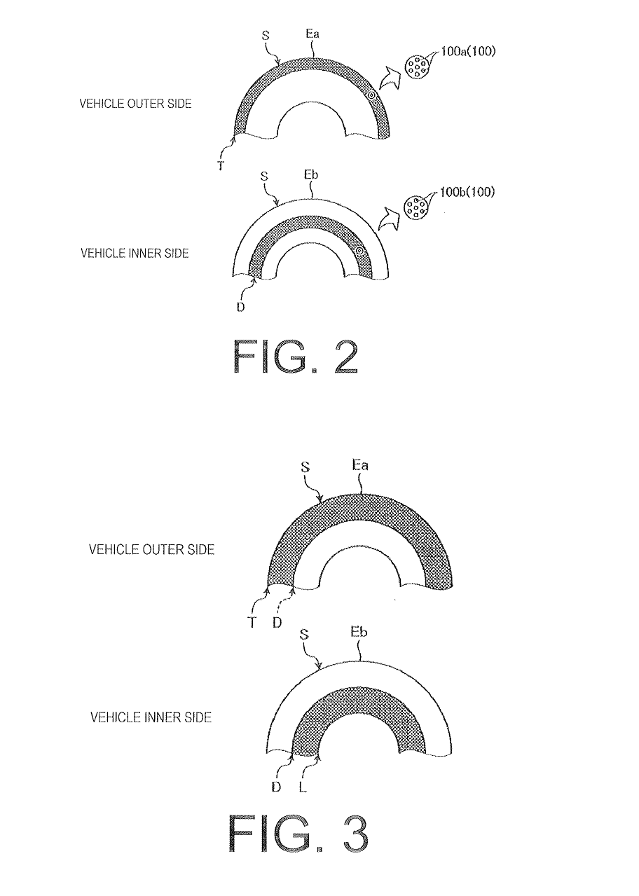

In a pneumatic tire 1 configured as described above, a tire side portion S is provided on both outer sides in the tire width direction and, as illustrated in FIG. 2, a plurality of recesses 100 is provided in a surface of the tire side portion S. FIG. 2 is a projection drawing illustrating an example of an outer side disposal region and an inner side disposal region of the pneumatic tire. Here, the “tire side portion S” refers to a region in the tire radial direction from a ground contact edge T of the tread portion 2 to a rim check line L. The “surface of the tire side portion S” refers to a surface that uniformly continues throughout said region in the tire circumferential direction and the tire radial direction.

The “ground contact edge T” refers to both outermost edges in the tire width direction of a region in which the tread surface 21 of the tread portion 2 of the pneumatic tire 1 contacts the road surface when the pneumatic tire 1 is assembled on a regular rim and filled with regular inner pressure and 70% of a regular load is applied, and continues in the tire circumferential direction. Moreover, the “rim check line L” refers to a line used to confirm whether the pneumatic tire 1 has been assembled on the rim correctly and, typically, is an annular convex line closer to the outer side in the tire radial direction than a rim flange and continues in the tire circumferential direction along a portion adjacent to the rim flange on a front side surface of the bead portions 5. Here, “regular rim” refers to a “standard rim” defined by the Japan Automobile Tyre Manufacturers Association Inc. (JATMA), a “design rim” defined by the Tire and Rim Association, Inc. (TRA), or a “measuring rim” defined by the European Tyre and Rim Technical Organisation (ETRTO). “Regular inner pressure” refers to “maximum air pressure” stipulated by JATMA, a maximum value in “tire load limits at various cold inflation pressures” defined by TRA, and “inflation pressures” stipulated by ETRTO. Note that “regular load” refers to “maximum load capacity” stipulated by JATMA, a maximum value in “tire load limits at various cold inflation pressures” defined by TRA, and “load capacity” stipulated by ETRTO.

As illustrated in FIG. 2, each of the recesses 100 is what is known as a dimple, and is formed so as to be sunken in the surface of the tire side portion S. Moreover, a plurality of the recesses 100 is disposed at a predetermined pitch in the tire radial direction and the tire circumferential direction. An opening shape of the recesses 100 opening at the surface of the tire side portion S may be circular, oval, elliptical, polygonal, or the like. Moreover, a cross-sectional shape of the recesses 100 may be semicircular, semi-oval, semi-elliptical, rounded cone shaped, rectangular, or the like. Note that while the recesses 100 in FIG. 2 are disposed in a staggered manner in the tire radial direction and the tire circumferential direction, they may be disposed in lines in the tire radial direction or disposed in lines in the tire circumferential direction.

In order for the recesses 100 to function to enable the air resistance reduction effect and the temperature increase suppression effect, a depth thereof is preferably not less than 0.5 mm and not more than 5.0 mm, an opening shape of the recesses 100 is preferably circular, and a diameter of said opening is preferably not less than 1.0 mm and not more than 8.0 mm. If the depth and the diameter are less than the lower limits described above, the turbulent flow generation effect and the surface area enlarging effect caused by the recesses 100 will be difficult to obtain. Moreover, if the depth exceeds the upper limit described above thickness needed for the tire inner structure cannot be ensured; and if the diameter exceeds the upper limit described above, the turbulent flow generation effect caused by the recesses 100 will be difficult to obtain.

The plurality of recesses 100 is constituted by a plurality of outer side recesses 100a provided on the tire side portion S of the vehicle outer side and a plurality of inner side recesses 100b provided in the tire side portion S of the vehicle inner side. Here, a region where the plurality of outer side recesses 100a is disposed is referred to as “outer side disposal region Ea” and a region where the plurality of inner side recesses 100b is disposed is referred to as “inner side disposal region Eb”.

A sum Vᵢₙ of volumes of the plurality of inner side recesses 100b provided in the inner side disposal region Eb is equal to a sum Vₒᵤₜ of volumes of the plurality of outer side recesses 100a provided in the outer side disposal region Ea. Here, the “volume of the recesses 100” is a hollow space sunken in the surface of the tire side portion S, and is calculated using factors of the opening area, the depth, the shape, and the like of the recesses 100. A recess volume ratio that expresses the relationship of the sum Vᵢₙ and the sum Vₒᵤₜ is “Vᵢₙ/Vₒᵤₜ=1” because the sum Vᵢₙ and the sum Vₒᵤₜ are equal.

The outer side disposal region Ea is provided so as to have a circular shape in the tire circumferential direction. The outer side disposal region Ea, in the tire radial direction, is a region including at least the ground contact edge T. As a result, the outer side disposal region Ea has a configuration including a region extending from the ground contact edge T to the inner side in the tire radial direction.

The inner side disposal region Eb is provided so as to have a circular shape in the tire circumferential direction, the same as the outer side disposal region Ea. In the tire radial direction, the inner side disposal region Eb is a region including at least a maximum width position D where the tire width is greatest. That is, the inner side disposal region Eb has a configuration including a region extending inward and outward in the tire radial direction from the maximum width position D, a region extending from the maximum width position D to the inner side in the tire radial direction, and a region extending from the maximum width position D to the outer side in the tire radial direction. Note that the maximum width where the tire width is greatest is a tire cross-sectional width.

The outer side disposal region Ea and the inner side disposal region Eb are different regions in a plane projected in a tire width direction. “Different regions” includes cases where the outer side disposal region La and the inner side disposal region Eb do not overlap, and also cases where a portion of the outer side disposal region Ea and a portion of the inner side disposal region Eb do overlap. Therefore, as illustrated in FIG. 2, as an example of a preferable outer side disposal region La and a preferable inner side disposal region Eb, the outer side disposal region Ea is configured as a region extending in the tire radial direction from the ground contact edge T to the inner side in the tire radial direction, and having a length that is 20% of the tire cross-sectional height. On the other hand, the inner side disposal region Eb is configured as a region extending inward and outward in the tire radial direction and sandwiches the maximum width position D where the tire width is greatest, and having a length in the tire radial direction that is 20% the tire cross-sectional height. Furthermore, compared with the inner side disposal region Eb, the outer side disposal region Ea is positioned on the outer side in the tire radial direction and, therefore, the outer side disposal region Ea is more expansive than the inner side disposal region Eb.

As described above, with the configuration of the pneumatic tire 1 according to this embodiment, the outer side disposal region La and the inner side disposal region Eb may be different regions in a plane projected in a tire width direction. Therefore, the inner side disposal region Eb is configured to have an arrangement suitable for the tire side portion S on the inner side in the width direction of the vehicle and, thereby, the ease of temperature increase in the tire side portion S on the vehicle inner side can be taken into consideration. Moreover, the outer side disposal region Ea is configured to have an arrangement suitable thr the tire side portion S on the outer side in the width direction of the vehicle and, thereby, the ease of separation of air of the tire side portion S on the vehicle outer side can be considered. As a result, the inner side disposal region Eb and the outer side disposal region Ea are suitably arranged in the pneumatic tire 1 and, thereby, the air resistance can be reduced and the temperature increases can be suppressed.

Additionally, with the configuration of the pneumatic tire 1 according to this embodiment, the outer side disposal region Ea can be configured as a region that includes at least the ground contact edge T, and the inner side disposal region Eb can be configured as a region that includes at least the maximum width position D. As a result, the outer side recesses 100a can be provided in the outer side disposal region Ea, in a portion where a velocity of the tire side portion S is greatest. That is, relative velocity of the pneumatic tire 1, when traveling, becomes substantially double that of the air at a position opposite the ground contact patch (top side) and, therefore, the outer side recesses 100a can be provided in a portion where the separation of air is great. Therefore, the outer side recesses 100a can be provided in the tire side portion S on the vehicle outer side where air separation is prone to occur and, thereby, the air resistance of the pneumatic tire 1 can be advantageously reduced. Additionally, the inner side recesses 100b can be provided in the inner side disposal region Eb, at a position where a change in curvature is great and, thereby, temperature increases can be advantageously suppressed around the maximum width position D of the tire side portion S on the vehicle inner side which is housed in the wheel housing and is prone to temperature increases. Particularly, with the configurations of the outer side disposal region Ea and the inner side disposal region Eb illustrated in FIG. 2, air resistance can be reduced while keeping the outer side disposal region Ea as small a region as possible, and temperature increases can be suppressed while keeping the inner side disposal region Eb as small a region as possible.

With the configuration of the pneumatic tire 1 according to this embodiment, in the different outer side disposal region Ea and the inner side disposal region Eb regions, the sum Vᵢₙ of the volumes of the plurality of inner side recesses 100b and the sum Vₒᵤₜ, of the volumes of the plurality of outer side recesses 100a can be configured to be equal. Therefore, air resistance can be reduced and temperature increases can be suppressed while maintaining the weight balance of the tire side portion S on the vehicle outer side and the tire side portion S on the vehicle inner side.

With the pneumatic tire 1 according to this embodiment, the outer side disposal region Ea and the inner side disposal region Eb are disposed as illustrated in FIG. 2, but the embodiment is not limited thereto and the outer side disposal region Ea and the inner side disposal region Eb may be disposed as illustrated in FIG. 3.

FIG. 3 is a projection drawing illustrating another example of an outer side disposal region and an inner side disposal region of the pneumatic tire. As illustrated in FIG. 3, as another example of a preferable outer side disposal region Ea and a preferable inner side disposal region Eb, the outer side disposal region Ea is a region extending in the tire radial direction from the ground contact edge T to the maximum width position D. Additionally, the inner side disposal region Eb is a region extending in the tire radial direction from the maximum width position D to the rim check line L.

Thus, with the configurations of the outer side disposal region Ea and the inner side disposal region Eb illustrated in FIG. 3, the outer side recesses 100a can be provided in the outer side disposal region Ea, at a position where the velocity is great and, thereby, air resistance can be advantageously reduced. Additionally, the inner side recesses 100b can be provided in the inner side disposal region Eb, at a position where a change in curvature is great and, thereby, temperature increases can be advantageously suppressed.

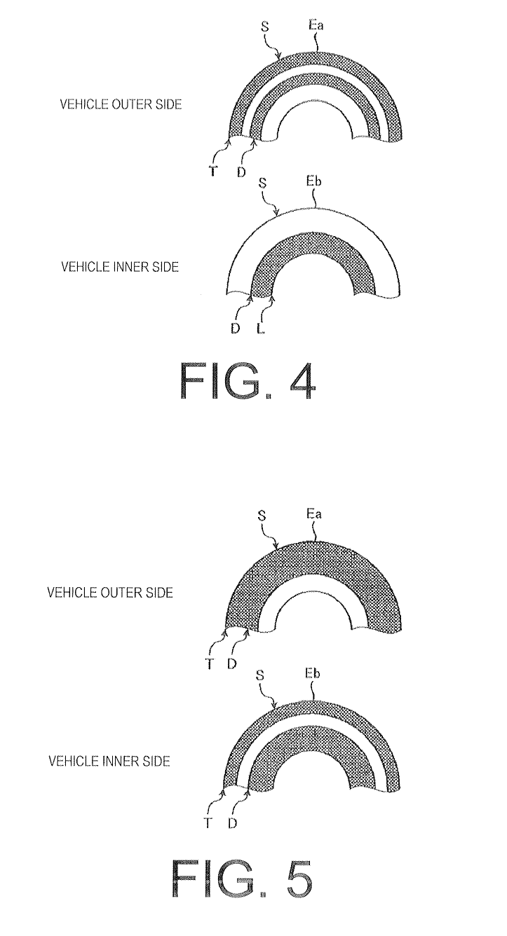

With the pneumatic tire 1 according to this embodiment, the outer side disposal region Ea and the inner side disposal region Eb are disposed as illustrated in FIG. 2, but the embodiment is not limited thereto and the outer side disposal region Ea and the inner side disposal region Eb may be disposed as illustrated in FIG. 4.

FIG. 4 is a projection drawing illustrating another example of an outer side disposal region and an inner side disposal region of the pneumatic tire. As illustrated in FIG. 4, as another example of a preferable outer side disposal region La and a preferable inner side disposal region Eb, the outer side disposal region Ea is configured as a region extending in the tire radial direction from the ground contact edge T to the inner side in the tire radial direction, and having a length that is 20% of the tire cross-sectional height. Additionally, the outer side disposal region Ea is a region sandwiching the maximum width position D and extending inward and outward in the tire radial direction. On the other hand, the inner side disposal region Eb is configured as a region extending in the tire radial direction from the maximum width position D to the rim check line L.

Thus, with the configurations of the outer side disposal region Ea and the inner side disposal region Eb illustrated in FIG. 4, the outer side recesses 100a can be provided in the outer side disposal region Ea, at a position where the velocity is great and, thereby, air resistance can be advantageously reduced. Moreover, the outer side recesses 100a can be provided in the outer side disposal region Ea, at a position where the change in curvature is great and, thereby, temperature increases can be advantageously suppressed. Additionally, the inner side recesses 100b can be provided in the inner side disposal region Eb, at a position where a change in curvature is great and, thereby, temperature increases can be advantageously suppressed.

With the pneumatic tire 1 according to this embodiment, the outer side disposal region Ea and the inner side disposal region Eb are disposed as illustrated in FIG. 2, but the embodiment is not limited thereto and the outer side disposal region Ea and the inner side disposal region Eb may be disposed as illustrated in FIG. 5.

FIG. 5 is a projection drawing illustrating another example of an outer side disposal region and an inner side disposal region of the pneumatic tire. As illustrated in FIG. 5, as another example of a preferable outer side disposal region La and a preferable inner side disposal region Eb, the outer side disposal region Ea is configured as a region extending in the tire radial direction from the ground contact edge T to the inner side in the tire radial direction, and this region has a length that is ⅔ of the tire cross-sectional height. On the other hand, the inner side disposal region Eb is configured as a region extending in the tire radial direction from the ground contact edge T to the inner side in the tire radial direction, and having a length that is 20% of the tire cross-sectional height. Additionally, the inner side disposal region Eb includes a region extending in the tire radial direction from the maximum width position D to the rim check line L.

Thus, with the configurations of the outer side disposal region Ea and the inner side disposal region Eb illustrated in FIG. 5, the outer side recesses 100a can be provided in the outer side disposal region Ea, at a position where the velocity is great and, thereby, air resistance can be advantageously reduced. Moreover, the outer side recesses 100a can be provided in the outer side disposal region Ea at a position where the change in curvature is great and, thereby, temperature increases can be advantageously suppressed. Additionally, the inner side recesses 100b can be provided in the inner side disposal region Eb, at a position where the velocity is great and, thereby, air resistance can be advantageously reduced. Moreover, the inner side recesses 100b can be provided in the inner side disposal region Eb at a position where the change in curvature is great and, thereby, temperature increases can be advantageously suppressed.

With the pneumatic tire 1 according to this embodiment, the sum Vᵢₙ of the volumes of the plurality of inner side recesses 100b and the sum Vₒᵤₜ of the volumes of the plurality of outer side recesses 100a are configured to be equal, but the sum Vᵢₙ of the volumes of the plurality of inner side recesses may be configured to be greater than the sum Vₒᵤₜ of the volumes of the plurality of outer side recesses. According to such a configuration, with the pneumatic tire 1, the temperature increase suppression effect in the tire side portion S on the vehicle inner side can be further enhanced, compared to the tire side portion S on the vehicle outer side. As a result, with the pneumatic tire 1 mounted on a vehicle, temperature increases can be advantageously suppressed in the tire side portion S on the vehicle inner side, which is housed in the wheel housing of the vehicle.

With the pneumatic tire 1 according to this embodiment, the sum Vᵢₙ of the volumes of the plurality of inner side recesses 100b and the sum Vₒᵤₜ of the volumes of the plurality of outer side recesses 100a are configured to be equal, but the sum Vₒᵤₜ of the volumes of the plurality of outer side recesses may be configured to be greater than the sum Vᵢₙ of the volumes of the plurality of inner side recesses. According to such a configuration, with the pneumatic tire 1, the air resistance reduction effect of the tire side portion S on the vehicle outer side can be further enhanced, compared to the tire side portion S on the vehicle inner side. As a result, with the pneumatic tire 1 mounted on a vehicle, separation of air of the tire side portion S on the exposed vehicle outer side can be suppressed and air resistance can be advantageously reduced.

### Examples

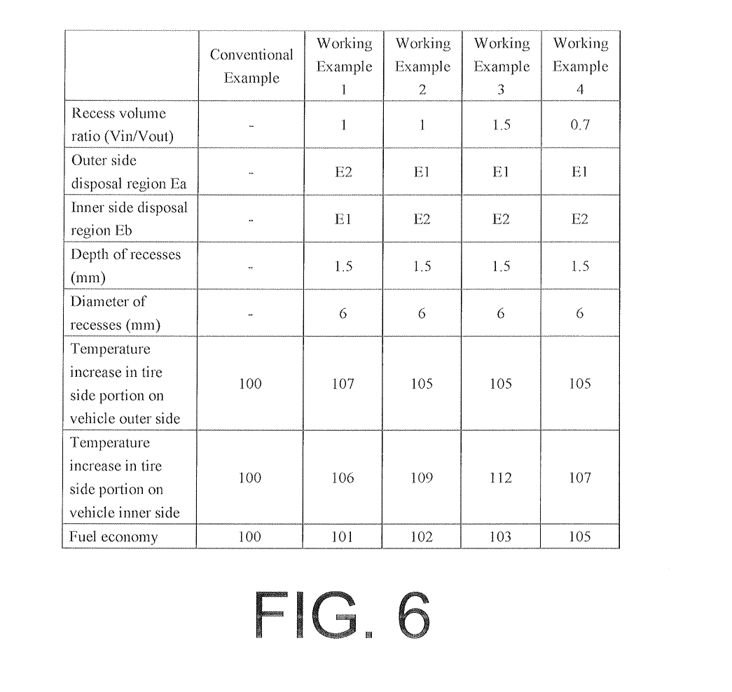

Next, Working Examples 1 to 4, in which the embodiment is applied, are described while referencing FIG. 6, and the temperature increase suppressing performance and air resistance reducing performance of the tire side portion S of each of Working Examples 1 to 4 are compared. Note that the Conventional Example, which is given for the purpose of comparison, is a pneumatic tire in which the outer side recesses 100a and the inner side recesses 100b are not provided in the tire side portion S of the vehicle outer side and the vehicle inner side. Here, the temperature increase suppressing performance and the air resistance reducing performance of the Conventional Example and of Working Examples 1 to 4 were evaluated under the following evaluation conditions.

As evaluation conditions, a pneumatic tire 1 having a size of 1.85/65R15 was used and this pneumatic tire 1 was mounted on a compact front-wheel drive car having an engine displacement of 1,300 cc. Then, the compact front-wheel drive car was driven 50 laps on a 2 km (total length) test course at a speed of 100 km/h.

With the pneumatic tire 1 according to Working Example 1, the recess volume ratio is Vᵢₙ/Vₒᵤₜ=1. The outer side disposal region Ea according to Working Example 1 is a second region E2 (see FIG. 1) extending inward and outward in the tire radial direction, having the maximum width position D where the tire width is greatest as a center in the tire radial direction. Each of the regions extending inward and outward in the tire radial direction of the second region E2, having the maximum width position D as the center, are regions that are ⅓ of an outer diameter side region E0 that extends from the ground contact edge T to the maximum width position D. The inner side disposal region Eb of Working Example 1 is a first region E1 (see FIG. 1) extending from the ground contact edge T to a position ⅓ of the outer diameter side region E0. Thus, with the pneumatic tire 1 of Working Example 1, the outer side disposal region Ea is not a region that includes the ground contact edge T, and the inner side disposal region Eb is not a region that includes the maximum width position D. The depth of the recesses 100 that are constituted by the outer side recesses 100a and the inner side recesses 100b is 2.5 mm and the diameter of the circular opening thereof is 6 mm.

With the pneumatic tire 1 according to Working Example 2, the recess volume ratio is Vᵢₙ/Vₒᵤₜ=1. The outer side disposal region Ea according to Working Example 2 is the first region E1 and the inner side disposal region Eb according to Working Example 2 is the second region E2. That is, the outer side disposal region Ea and the inner side disposal region Eb in the pneumatic tire 1 of Working Example 2 have an inverted configuration when compared to the configuration of the outer side disposal region Ea and the inner side disposal region Eb of the pneumatic tire 1 of Working Example 1. Thus, with the pneumatic tire 1 of Working Example 2, the outer side disposal region La is a region that includes the ground contact edge T, and the inner side disposal region Eb is a region that includes the maximum width position D. The depth of the recesses 100 that are constituted by the outer side recesses 100a and the inner side recesses 100b is 1.5 mm and the diameter of the circular opening thereof is 6 mm.

With the pneumatic tire 1 according to Working Example 3, the recess volume ratio is Vᵢₙ/Vₒᵤₜ=1.5. The outer side disposal region Ea according to Working Example 3 is the first region E1 and the inner side disposal region Eb according to Working Example 3 is the second region E2. The depth of the recesses 100 that are constituted by the outer side recesses 100a and the inner side recesses 100b is 1.5 mm and the diameter of the circular opening thereof is 6 mm.

With the pneumatic tire 1 according to Working Example 4, the recess volume ratio is Vᵢₙ/Vₒᵤₜ=0.7. The outer side disposal region La according to Working Example 4 is the first region E1 and the inner side disposal region Eb according to Working Example 4 is the second region E2. The depth of the recesses 100 that are constituted by the outer side recesses 100a and the inner side recesses 100b is 1.5 mm and the diameter of the circular opening thereof is 6 mm.

The temperature increase suppressing performance and the air resistance reducing performance of the pneumatic tire 1 of Working Examples 1 to 4 are compared in a case where the temperature increase suppressing performance and the air resistance reducing performance of the pneumatic tire of the Conventional Example are set to 100. Higher index scores of the amount of temperature increase of the tire side portion S indicate enhanced temperature increase suppressing performance. The index score of the amount of temperature increase is calculated as [(temperature in Celsius of the Conventional Example/temperature in Celsius of the Working Example)×100]. That is higher index scores indicate a greater degree of suppression of temperature increases. Additionally, higher index scores for fuel economy indicate enhanced air resistance reducing performance.

As illustrated in FIG. 6, with the pneumatic tire 1 of Working Example 1, the amount of temperature increase of the tire side portion S on the vehicle outer side is 107 and the amount of temperature increase of the tire side portion S on the vehicle inner side is 106. The fuel economy is 101. From the above, it was confirmed that the temperature increase suppressing performance and the air resistance reducing performance were enhanced, compared to the Conventional Example. On the other hand, with the pneumatic tire 1 of Working Example 1, it is clear that the temperature increase suppression effect in the tire side portion S on the vehicle outer side, which is exposed to the outside of the vehicle, is greater compared to the temperature increase suppression effect in the tire side portion S on the vehicle inner side, which is housed in the wheel housing of the vehicle.

With the pneumatic tire of Working Example 2, the amount of temperature increase of the tire side portion S on the vehicle outer side is 105 and the amount of temperature increase of the tire side portion S on the vehicle inner side is 109. The fuel economy is 102. From the above, it was confirmed that the temperature increase suppressing performance and the air resistance reducing performance were enhanced, compared to the Conventional Example. Additionally, while the temperature increase suppression effect in the tire side portion S on the vehicle outer side is reduced compared to Working Example 1, the temperature increase suppression effect in the tire side portion S on the vehicle inner side is enhanced. Moreover, enhanced air resistance reducing performance was confirmed. Therefore, with the pneumatic tire 1 of Working Example 2, it is clear that the temperature increase suppression effect in the tire side portion S on the vehicle inner side, which is housed in the wheel housing of the vehicle, is greater compared to the temperature increase suppression effect in the tire side portion S on the vehicle outer side, which is exposed to the outside of the vehicle. Moreover, temperature increases in the tire side portion S on the vehicle inner side, which is prone to temperature increases, can be advantageously suppressed. Additionally, with the pneumatic tire 1 of Working Example 2, the air resistance reducing performance is enhanced and, therefore, air resistance at the tire side portion S on the vehicle outer side where air is prone to separate can be advantageously reduced. As a result, with the pneumatic tire 1 of Working Example 2, it is clear that the outer side disposal region Ea is suitably disposed in the tire side portion S on the vehicle outer side, and that the inner side disposal region Eb is suitably disposed in the tire side portion S on the vehicle inner side.

With the pneumatic tire 1 of Working Example 3, the amount of temperature increase of the tire side portion S on the vehicle outer side is 105 and the amount of temperature increase of the tire side portion S on the vehicle inner side is 112. The fuel economy is 103. From the above, it was confirmed that the temperature increase suppressing performance and the air resistance reducing performance were enhanced, compared to the Conventional Example. Additionally, it is clear that the temperature increase suppression effect in the tire side portion S on the vehicle inner side could be enhanced compared to Working Example 2 because the sum Vᵢₙ of the volumes of the plurality of inner side recesses 100b was configured to be greater than the sum Vₒᵤₜ of the volumes of the plurality of outer side recesses 100a.

With the pneumatic tire 1 of Working Example 4, the amount of temperature increase of the tire side portion S on the vehicle outer side is 105 and the amount of temperature increase of the tire side portion S on the vehicle inner side is 107. The fuel economy is 105. From the above, it was confirmed that the temperature increase suppressing performance and the air resistance reducing performance were enhanced, compared to the Conventional Example. Additionally, it is clear that the air resistance reduction effect could be enhanced compared to Working Example 2 because the sum Vₒᵤₜ of the volumes of the plurality of outer side recesses 100a was configured to be greater than the sum Vᵢₙ of the volumes of the plurality of inner side recesses 100b.

What is claimed is:

1. A pneumatic tire having tire side portions on both sides that form regions extending from a ground contact edge to a rim check line, the pneumatic tire comprising:
a plurality of inner side recesses provided in a surface of the tire side portion on an inner side in a width direction of a vehicle, when mounted on a vehicle; and
a plurality of outer side recesses provided in a surface of the tire side portion on an outer side in a width direction of a vehicle, when mounted on a vehicle; wherein
a region where the plurality of inner side recesses is provided is an inner side disposal region and a region where the plurality of outer side recesses is provided is an outer side disposal region, and
the inner side disposal region and the outer side disposal region are different regions in a plane projected in a tire width direction.

2. The pneumatic tire according to claim 1, wherein, in a tire radial direction, the outer side disposal region is a region comprising at least the ground contact edge, and
in the tire radial direction, the inner side disposal region is a region comprising at least a maximum width position where the tire width is greatest.

3. The pneumatic tire according to claim 1, wherein a sum of volumes of the plurality of inner side recesses and a sum of volumes of the plurality of outer side recesses are equal.

4. The pneumatic tire according to claim 1, wherein a sum of volumes of the plurality of inner side recesses is greater than a sum of volumes of the plurality of outer side recesses.

5. The pneumatic tire according to claim 1, wherein a sum of volumes of the plurality of outer side recesses is greater than a sum of volumes of the plurality of inner side recesses.

6. The pneumatic tire according to claim 1, wherein a depth of the inner side recesses and the outer side recesses is not less than 0.5 mm and not more than 5.0 mm.

7. The pneumatic tire according to claim 1, wherein an opening of the inner side recesses and the outer side recesses is circular, and a diameter of said opening is not less than 1.0 mm and not more than 8.0 mm.

8. The pneumatic tire according to claim 1, wherein an opening of the inner side recesses and the outer side recesses is circular.

9. The pneumatic tire according to claim 1, wherein the outer side disposal region is configured as a region extending in the tire radial direction from the ground contact edge to the inner side in the tire radial direction, and having a length that is 20% of the tire cross-sectional height.

10. The pneumatic tire according to claim 9, wherein the inner side disposal region is configured as a region extending inward and outward in the tire radial direction and sandwiches the maximum width position where the tire width is greatest, and the inner side disposal region has a length in the tire radial direction that is 20% the tire cross-sectional height.

11. The pneumatic tire according to claim 1, wherein the inner side disposal region is configured as a region extending inward and outward in the tire radial direction and sandwiches the maximum width position where the tire width is greatest, and the inner side disposal region has a length in the tire radial direction that is 20% the tire cross-sectional height.

12. The pneumatic tire according to claim 1, wherein the outer side disposal region is a region extending in the tire radial direction from the ground contact edge to the maximum width position and the inner side disposal region is a region extending in the tire radial direction from the maximum width position to the rim check line.

13. The pneumatic tire according to claim 1, wherein the outer side disposal region is configured as a region extending in the tire radial direction from the ground contact edge to the inner side in the tire radial direction, and having a length that is 20% of the tire cross-sectional height, the outer side disposal region being a region sandwiching the maximum width position and extending inward and outward in the tire radial direction.

14. The pneumatic tire according to claim 13, wherein the inner side disposal region is configured as a region extending in the tire radial direction from the maximum width position to the rim check line.

15. The pneumatic tire according to claim 1, wherein the outer side disposal region is configured as a region extending in the tire radial direction from the ground contact edge to the inner side in the tire radial direction, and the outer side disposal region has a length that is ⅔ of the tire cross-sectional height.

16. The pneumatic tire according to claim 15, wherein the inner side disposal region is configured as a region extending in the tire radial direction from the ground contact edge to the inner side in the tire radial direction, and the inner side disposal region has a length that is 20% of the tire cross-sectional height.

17. The pneumatic tire according to claim 16, wherein the inner side disposal region includes a region extending in the tire radial direction from the maximum width position to the rim check line.

18. The pneumatic tire according to claim 1, wherein the inner side disposal region is configured as a region extending in the tire radial direction from the ground contact edge to the inner side in the tire radial direction, and the inner side disposal region has a length that is 20% of the tire cross-sectional height; and wherein the inner side disposal region includes a region extending in the tire radial direction from the maximum width position to the rim check line.

19. The pneumatic tire according to claim 1, wherein the plurality of inner side recesses or the plurality of outer side recesses are disposed in a staggered manner in the tire radial direction and the tire circumferential direction.

20. The pneumatic tire according to claim 1, wherein the plurality of inner side recesses or the plurality of outer side recesses are disposed in lines in the tire radial direction or disposed in lines in the tire circumferential direction.
